(19) United States
(12) Patent Application Publication
(10) Pub. No.: US 2010/0138988 A1
(43) Pub. Date: Jun. 10, 2010

(54) RADIO CONTROLLED SHOWER HEAD

(76) Inventor: Kelly David Holmes, Spanish Fork, UT (US)

Correspondence Address: ANGUS C. FOX, III, 4093 N. IMPERIAL WAY, PROVO, UT, 84604-5386, US

(21) Appl. No.: 12/622,913

(22) Filed: Nov. 20, 2009

Related U.S. Application Data
(60) Provisional application No. 61/119,816, filed on Dec. 4, 2008.

(51) Int. Cl. A47K 3/28; F16K 31/02

(52) U.S. Cl. 4/605; 251/129.22

(57) ABSTRACT

A system for controlling water flow through a shower head includes a shower mat made of resilient material having a transmitter, an electrical power supply, and a switch embedded and hermetically sealed therein. The switch, when activated by a bather, sends a power pulse provided by the power supply to the transmitter, which transmits a control signal in response to each received power pulse. Separate from the shower mat, the system also includes a low-voltage DC power source, a receiver powered by the power source, and control logic which alternately activates and deactivates a driver transistor of a solenoid control circuit in response to the receipt of control signals received by the receiver from the transmitter. A solenoid-controlled valve in line with water flow to the shower head has a control solenoid with an input that is coupled to the low-voltage power source through the driver transistor.

This application has a priority date based on Provisional Patent Application No. 61/119,816, which has a filing date of Dec. 04, 2008, and is titled SHOWER MATE.

### BACKGROUND OF THE INVENTION

1. Field of the Invention

The present invention relates, generally, to electronic remote control systems and, more particularly, to control systems for remotely controlling the flow of water from a shower head used for bathing.

2. History of the Prior Art

Conventional mixer/shut-off valves are not particularly effective at minimizing the amount of water used during a shower. Water is really only needed by a bather for an initial wetting down and a final rinse. Running water is not required for lathering the hair or for scrubbing the body with body wash or soap on a wetted wash cloth. Most bathers step out of the shower head flow while lathering down because they do not want to bother with shutting off the water flow, subsequently turning on the water and having to likely deal with readjustment of the hot and cold water mix. The problem of achieving the optimum mix and flow is particularly acute when the mix of hot and cold water is provided by separate hot and cold water valves. Thus, heated water continues to flow unabated, resulting in a waste of both potable water and the energy used to heat it. Although shower heads may be fitted with a manually-operable shut-off valve, most bathers consider such devices a nuisance and refuse to use them. Consequently, potable water and energy is needlessly allowed to flow down the drain. Additionally, physically handicapped or injured individuals may be incapable of manipulating the controls of a conventional mixer/shut-off shower valve assembly.

What is needed is a system for controlling water flow from a shower head used for bathing using only foot pressure .

### SUMMARY OF THE INVENTION

The present invention fulfills the heretofore expressed need for a system for controlling the flow of water through a shower head without the use of hand-actuated controls. In its most basic form, the system includes a shower mat made of resilient material having a transmitter, an electrical power supply, and a switch embedded and hermetically sealed therein. The switch, when activated by a bather, sends a power pulse provided by the power supply to the transmitter, which transmits a control signal in response to each received power pulse. Separate from the shower mat, the system also includes a low-voltage DC power source, a receiver powered by the power source, and control logic which alternately activates and deactivates a driver transistor of a solenoid control circuit in response to the receipt of control signals received by the receiver from the transmitter. A solenoid-controlled valve in line with water flow to the shower head has a control solenoid with an input that is coupled to the low-voltage power source through the driver transistor. For a presently preferred embodiment of the invention, the electrical power supply is an energy-harvesting device, which enables the components embedded within the shower mat to be permanently and hermetically sealed therein at the time of manufacture. Usable energy-harvesting devices include one or more photovoltaic cells and electro-dynamic generators activated by the switch. Electrical current generated by photovoltaic cells can be either capacitively or electrochemically stored. Electro-dynamic generators, which are typically designed to move a coil through the magnetic field of a permanent magnet, generate pulses which are used at the moment of generation. For a less preferred embodiment of the invention, the power supply can be at least one replaceable electrochemical cell. One or more O-ring seals on a removable plug can be used to prevent the entry of moisture into the cell/battery compartment.

### BRIEF DESCRIPTION OF THE DRAWINGS

FIG. 1 is a block system diagram of the radio-controlled shower head;

FIG. 2 is a block diagram of embedded switching and transmitter shower mat components having an energy-harvesting electrodynamic switch/generator;

FIG. 3 is a block diagram of embedded shower mat components having an energy-harvesting photovoltaic cell and a capacitor as a power source;

FIG. 4 is a block diagram of embedded switching and transmitter shower mat components having an energy-harvesting photovoltaic cell and an electrochemical storage device as a power source;

FIG. 5 is a block diagram of embedded switching and transmitter shower mat components having an energy-harvesting piezoelectric switch/generator;

FIG. 6 is a block diagram of embedded switching and transmitter shower mat components having an electrochemical storage device as a power source; and

FIG. 7 is an isometric view of a shower mat in which are embedded the switching and transmitter components.

### DETAILED DISCLOSURE OF THE INVENTION

The radio-controlled shower head will now be described in detail with reference to the attached drawing figures. It should be understood that the figures are not necessarily drawn to scale and that they are intended to be merely illustrative of the invention.

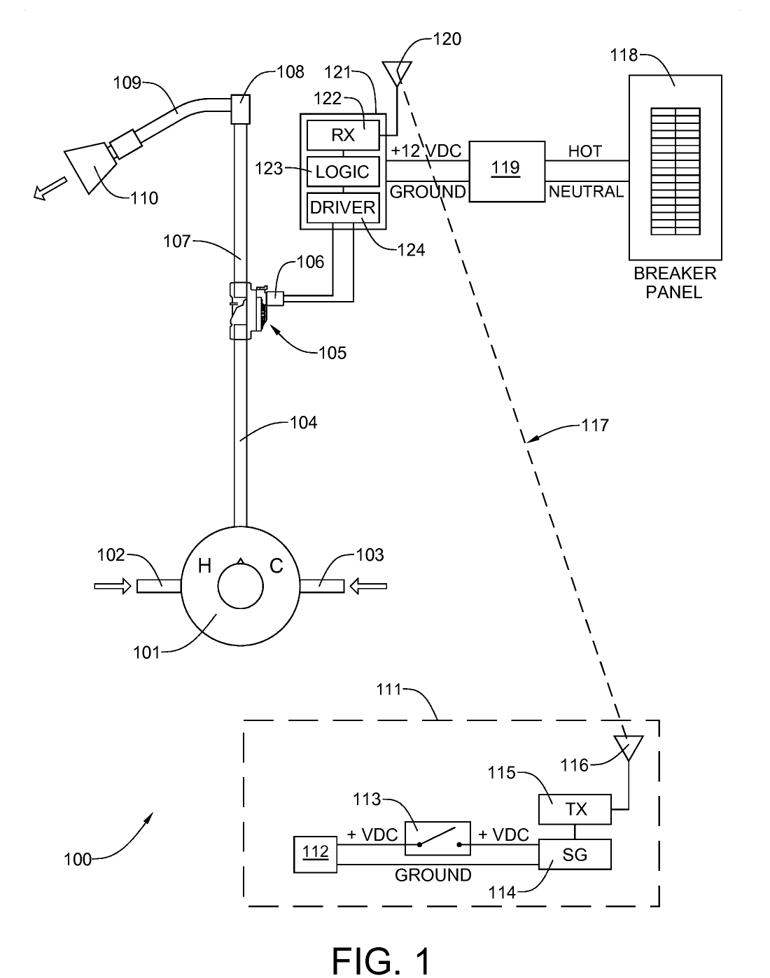

Referring now to FIG. 1, a complete system 100 for controlling the flow of water from a shower head using radio signals transmitted from a shower mat includes a conventional water mixer/shut-off valve 101 having a first input 102 for hot water, a second input 103 for cold water, and an outlet 104 for mixed hot and cold water. The system 100 also includes a full-on/full-off valve 105 having a low-voltage DC control solenoid 106, which provides for full flow of water through the full-on/full-off valve 105 when the solenoid 106 is activated and full shut-off of water flow through the full-on/full-off valve 105 when deactivated. The full-on/full-off valve 105 is coupled to both the outlet tube 104 and a riser tube 107. The opposite end of the riser tube 107 is coupled to an elbow 108 having a threaded horizontal socket. A curved connector tube 109 couples a shower head 110 to the elbow 108.

Still referring to FIG. 1, a shower mat module 111 includes a low-voltage DC power source 112, a switch 113, a signal generator 114, a transmitter 115, and a transmitting antenna 116 coupled to the transmitter 115. The switch 113, when activated by a bather, sends voltage pulses to the signal generator 113, which generates an encoded signal that is sent to the transmitter 115 and broadcast from the antenna 116 as a radio signal 117.

Still referring to FIG. 1, a circuit breaker panel 118 provides power to an AC to DC power converter 119, which in turn provides rectified 12-volt DC power to a control module 121. The control module includes a receiving antenna 120, a receiver 122, control logic 123, and a solenoid driver transistor 124. The receiving antenna 120 receives encoded radio signals 117 from the shower mat module 111. The receiving antenna 120 is coupled to a receiver 122, which decodes the received signal. The control logic 123 alternately activates and deactivates the solenoid driver transistor in response to the receipt of control signals received by the receiver 122 from the transmitter 115. The full-on/full-off valve 105 having a control solenoid 106 receives sequential activation and deactivation. Activation occurs when current is flowing through the driver transistor 124 to the solenoid 106, and deactivation occurs when current flow is cut. The solenoid 106 is preferably of the DC type, as DC solenoids are much quieter than AC solenoids. For a preferred embodiment of the invention, the transmitter 115 and the receiver 122 employ the low-cost, low-power proprietary wireless networking standard established by the ZigBee® Alliance.

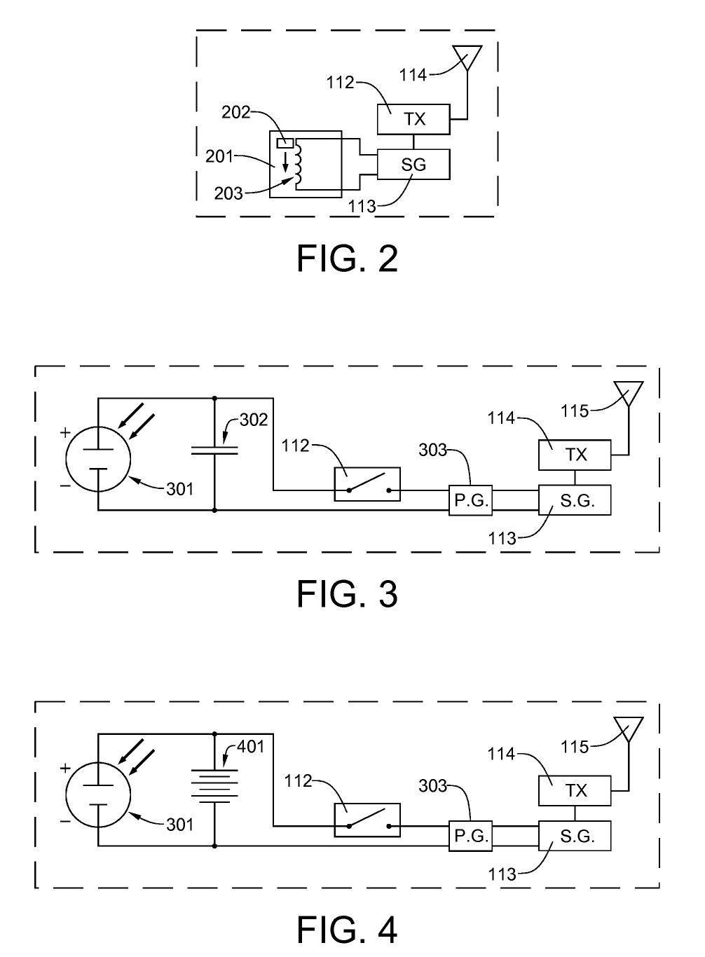

Referring now to FIG. 2, the low-voltage DC power source 112 and switch 113 of the shower mat module 111 of FIG. 1 have been combined into a single energy-harvesting electrodynamic switch/generator unit 201. Unit 201 includes a permanent magnet 201 coupled to a switch member that is rapidly moved as the switch member snaps from a compressed first state to a second state when pressed by a bather. The magnetic field of the magnet 201 in proximity to a coil, thereby generating an electrical pulse having a shape, duration and power that is repeatable because of the snapping nature of the switch member. The EnOcean PTM200 868 MHz transmitter module described below includes all the circuitry required to implement the mat module 111 of FIG. 2, including an electrodynamic switch/generator unit, a signal encoder and a transmitter.

Referring now to FIG. 3, the low-voltage DC power source 112 of the shower mat module 111 of FIG. 1 is a photovoltaic cell 301 that generates electrical current when exposed to light in the visible spectrum. The current is stored as a charge on a capacitor 302. When switch 112 is activated by a bather, the charge escapes from the capacitor 302 and is shaped into an appropriate pulse of appropriate duration and shape by pulse generator 303. The EnOcean STM110 transmitter module described below includes all the circuitry required to implement the mat module 111 of FIG. 3, including a photovoltaic cell, a charge storage device, a switch, a pulse generator, a signal encoder, and a transmitter.

Referring now to FIG. 4, the low-voltage DC power source 112 of the shower mat module 111 of FIG. 1 is similar to that of FIG. 3, with the exception that current from the photovoltaic cell 301 is stored in a rechargeable electrochemical cell or battery 401. The EnOcean STM110 transmitter module described below includes all the circuitry required to implement the mat module 111 of FIG. 3, including a photovoltaic cell, a charge storage device, a switch, a pulse generator, a signal encoder, and a transmitter.

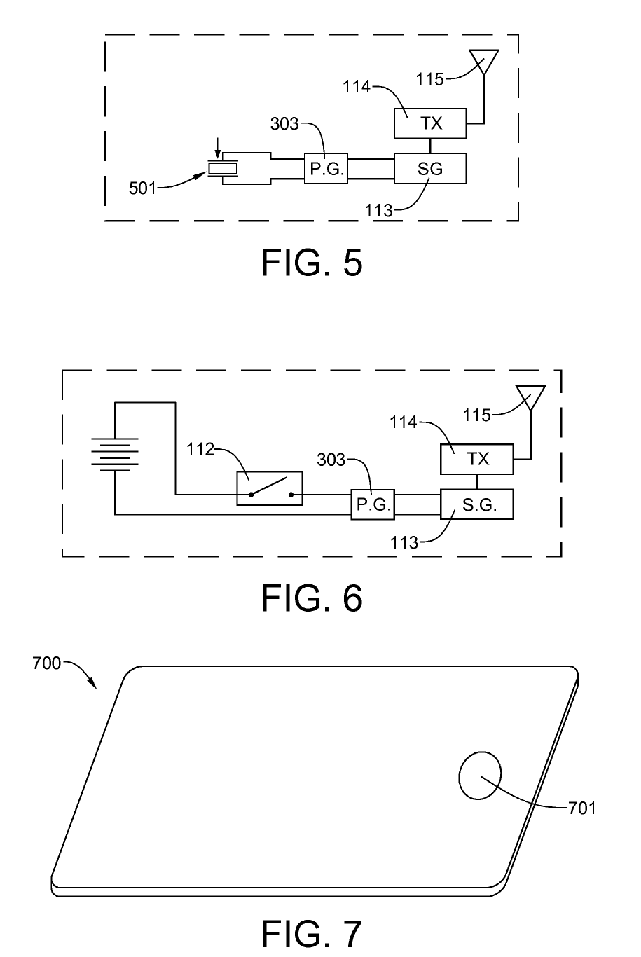

Referring now to FIG. 5, the low-voltage DC power source 112 of the shower mat module 111 of FIG. 1 is a piezoelectric generator 501. When pressure is applied to the generator 501 by a bather, current flows to a pulse generator, where it is shaped into a pulse of appropriate duration and shape.

Referring now to FIG. 6, the low-voltage DC power source 112 of the shower mat module 111 of FIG. 1 is an electrochemical cell or battery 601. When switch 112 is activated by a bather, current flows from the cell or battery 601 to the pulse generator 301, where it is shaped into a pulse of appropriate duration and shape.

Referring now to FIG. 7, the shower mat module is embedded within a shower mat 700 in a region 701 that is slightly thickened to accommodate the circuitry and throw of the various types of switches. It is advisable to embed a rigid laminar sheet below the circuitry in order to prevent it from breaking or cracking if the mat 700 is flexed.

EnOcean GmbH is a venture-funded spin-off company of Siemens AG that was founded in 2001. Headquartered in Oberhaching, Germany, the company manufactures maintenance-free, batteryless, wireless sensor solutions for use in buildings and industrial installations. EnOcean has developed a technology that is based on the energetically efficient exploitation of applied slight mechanical excitation and other potentials from the ambiance using the principles of energy harvesting. In order to transform such energy fluctuations into usable electrical energy, electromagnetic, piezogenerators, solar cells, thermocouples, and other energy converters are used. The EnOcean products includes sensors and radio switches, from which radio signals can be transmitted wireless over a distances of up to 300 meters in the open and up to 30 meters inside buildings. Although early designs from the company used piezo-electric generators, these were subsequently replaced with electromagnetic generators in order to reduce high operating pressures (7 newtons), and increase the service life to 50,000 operations. Packets of data are transmitted at 120 kbit/s with the packet being 14 bytes long with a four byte data payload. RF energy is transmitted only for the 1's of the data, thereby reducing the amount of power required. Three packets are sent at pseudo-random intervals reducing the possibility of packet collisions. Push switches also transmit a further three data packets on release of the switch push-button, enabling other features such as light dimming to be implemented. Every device has a unique 32-bit serial number, so local ambiguity is avoided by ‘training’ a receiver to recognize specific transmitters. The transmission frequency used for switches and sensors is either 868.3 MHz or 315 MHz. Telegrams are just one millisecond in duration and are transmitted at a rate of 125 kilobits per second. In order to eliminate transmission errors, a telegram is repeated twice in the space of 30 milliseconds.

The EnOcean STM110 transmitter module utilizes energy generated by a small solar cell. An integrated energy store allows unrestricted functionality for several days in total darkness. Together with a companion receiver module RCM120 this module can be easily implemented into operation and control units for realization of different application specific system solutions.

The EnOcean PTM200 868 MHz transmitter module is a miniaturized radio transmitter (40 mm×40 mm×11.2 mm) that employs an electromagnetic generator in the form of a moving magnet and coil incorporated in a very slim rocker switch. A companion receiver module RCM 110 can control up to four relays or one dimmer. This combination is ideal for the application of the present invention.

Although only several embodiments of the present invention have been disclosed herein, it will be obvious to those having ordinary skill in the art that changes and modifications may be made thereto without departing from the scope and spirit of the invention as hereinafter claimed.

What is claimed is:

1. A system for controlling flow of water through a shower head comprising:
a shower mat having an embedded transmitter, an embedded energy-harvesting electrical power supply, and an embedded switch, said switch sending a power pulse provided by said electrical power supply to said transmitter when said switch is activated by pressure of a bather's foot, said transmitter transmitting a control signal in response to each received power pulse;
a low-voltage DC power source;
a receiver, powered by said DC power source, said receiver and said transmitter operating on a common frequency, and said receiver having control logic which alternately activates and deactivates a driver transistor of a solenoid control circuit in response to a receipt of control signals from said transmitter; and
a solenoid-controlled valve in line with water flow to the shower head, said valve having a control solenoid with an input that is coupled to said low-voltage DC power source through said driver transistor.

2. The system for controlling of claim 1, wherein said energy-harvesting power supply comprises at least one solar cell.

3. The system for controlling of claim 2, wherein the energy generated by said at least one solar cell is stored in at least one rechargeable electrochemical cell.

4. The system for controlling of claim 2, wherein the energy generated by said at least one solar cell is capacitively stored.

5. The system for controlling of claim 1, wherein said energy-harvesting power supply is an electrodynamic generator incorporated in the embedded switch.

6. The system for controlling of claim 1, wherein said solenoid-controlled valve is placed between the shower head and a conventional mixer/shut-off valve.

7. The system for controlling of claim 1, wherein said shower mat is made of a resilient, light-transmissible material.

8. The system for controlling of claim 1, wherein said resilient material is a polymer selected from the group consisting of RTV silicone rubber, HTV silicone rubber, vulcanized ethylene propylene copolymer, chlorinated polyethylene, chlorosulfonated polyethylene, polybutadiene rubber, polyolefin elastomers, polyurethane elastomers, butadiene styrene copolymer rubbers, polychloroprene rubber, hydrocarbon rubbers, polyisobutylene, butyl rubber and polyisoprene rubbers.

9. A system for controlling flow of water through a shower head comprising:
a shower mat made of resilient material having a transmitter, an electrical power supply, and a switch, said transmitter, said electrical power supply and said switch being embedded and hermetically sealed within said mat, and said switch sending a power pulse provided by said electrical power supply to the transmitter when said switch is activated by a bather, said transmitter transmitting a control signal in response to each received power pulse;
a low-voltage DC power source;
a receiver, powered by said DC power source, said receiver and said transmitter operating on a common frequency, and said receiver having control logic which alternately activates and deactivates a driver transistor of a solenoid control circuit in response to a receipt of control signals from said transmitter; and
a solenoid-controlled valve in line with water flow to the shower head, said valve having a control solenoid with an input that is coupled to said low-voltage DC power source through said driver transistor.

10. The system for controlling of claim 9, wherein said electrical power supply is an energy-harvesting device.

11. The system for controlling of claim 10, wherein said energy-harvesting device comprises at least one solar cell.

12. The system for controlling of claim 11, wherein the energy generated by said at least one solar cell is stored in at least one rechargeable electrochemical cell.

13. The system for controlling of claim 11, wherein the energy generated by said at least one solar cell is capacitively stored.

14. The system for controlling of claim 10, wherein said energy-harvesting power supply is an electrodynamic generator incorporated in the embedded switch.

15. The system for controlling of claim 9, wherein said electrical power supply comprises at least one electrochemical cell.

16. The system for controlling of claim 9, wherein said solenoid-controlled valve is placed between the shower head and a conventional mixer/shut-off valve.

17. The system for controlling of claim 9, wherein said resilient material is a polymer selected from the group consisting of RTV silicone rubber, HTV silicone rubber, vulcanized ethylene propylene copolymer, chlorinated polyethylene, chlorosulfonated polyethylene, polybutadiene rubber, polyolefin elastomers, polyurethane elastomers, butadiene styrene copolymer rubbers, polychloroprene rubber, hydrocarbon rubbers, polyisobutylene, butyl rubber and polyisoprene rubbers.

18. A system for controlling flow of water through a shower head comprising:
a shower mat made of resilient, polymeric, light-transmissible thermoplastic material having an transmitter, an energy-harvesting electrical power supply comprising at least one photocell and an associated charge storage device, and a switch, said transmitter, said electrical power supply and said switch being embedded and hermetically sealed within said mat, and said switch sending a power pulse provided by said charge storage device to the transmitter when said switch is activated by a bather, said transmitter transmitting a control signal in response to the received power pulse;
a low-voltage DC power source;
a receiver, powered by said DC power source, said receiver and said transmitter operating on a common frequency, and said receiver having control logic which alternately activates and deactivates a driver transistor of a solenoid control circuit in response to a receipt of control signals from said transmitter; and
a solenoid-controlled valve in line with water flow to the shower head, said valve having a control solenoid with an input that is coupled to said low-voltage DC power source through said driver transistor.

19. The system for controlling of claim 18, wherein said charge storage device comprises at least one rechargeable electrochemical cell.

20. The system for controlling of claim 18, wherein said charge storage device comprises at least one capacitor.
